(19) United States
(12) Patent Application Publication
(10) Pub. No.: US 2015/0091410 A1
(43) Pub. Date: Apr. 2, 2015

(54) AXIAL FLUX ELECTRICAL MACHINES AND METHODS OF MANUFACTURING THE SAME.

(71) Applicants: Regal Beloit Australia Pty Ltd., Rowville (AU); Regal Beloit America, Inc., Beloit, WI (US)

(72) Inventors: Steven Wilfred Post, Cassville, MO (US); Nicholas Neville Lambert, Frankston South (AU); Greg Heins, Aspendale (AU)

(73) Assignees: Regal Beloit Australia Pty Ltd., Rowville (AU); Regal Beloit America, Inc., Beloit, WI (US)

(21) Appl. No.: 14/044,484

(22) Filed: Oct. 2, 2013

(51) Int. Cl. H02K 1/14; H02K 15/02

(52) U.S. Cl. CPC H02K 1/14; H02K 15/022
USPC 310/216.093; 29/596

(57) ABSTRACT

An axial flux electric machine comprises a rotor assembly configured to rotate about an axis of rotation. A stator core is coupled to the rotor assembly. The stator core comprises a stator core base and a plurality of circumferentially-spaced stator teeth extending from the base in a direction parallel to the axis. Each stator tooth of the plurality of stator teeth comprises a top surface, a pair of opposing circumferential sides, and a chamfered portion defined at an intersection of the top surface and each of the pair of opposing sides. The chamfered portion facilitates reducing an amount of torque ripple produced by the axial flux electric motor.

### BACKGROUND

The embodiments described herein relate generally to axial flux electrical machines, and more particularly, to methods and systems for reducing torque ripple using a stator core in an axial flux electric machine.

Permanent magnet electrical machines are used in a wide variety of systems operating in a wide variety of industries, such as in pump systems or air handling units. As such, permanent magnet electrical machines are subject to many operating conditions. Any source of periodic divergence from ideal operating conditions in the machine typically gives rise to undesired torque pulsations, which may cause vibrations, and potentially motor noise, any amount of which may be objectionable to a user. In such a machine, pulsating torque may be caused by torque ripple, which is when the back electromotive force from a plurality of permanent magnets deviates from a purely sinusoidal waveform, causing higher frequencies above a fundamental frequency of the machine.

Audible machine noise is unacceptable in many applications. Further, the cogging and the torque pulses at the shaft of the machine may be transmitted to a fan, blower assembly or other driven equipment/end device that is attached to the shaft. In such applications these torque pulses and the effects of torque ripple may result in operational deficiencies and/or acoustical noise that can be objectionable to an end user of the machine. As such, reducing the torque ripple in the machine facilitates reducing the amount of acoustic interference generated by the device powered by the machine.

### BRIEF DESCRIPTION

In one aspect, a stator core for an axial flux electric machine is provided. The stator core comprises an axis of rotation, a stator core base, and a plurality of circumferentially-spaced stator teeth extending from the base in a direction parallel to the axis. Each stator tooth of the plurality of stator teeth comprises a top surface, a pair of opposing circumferential sides, and a modified portion defined at an intersection of the top surface and each of the pair of opposing sides. The modified portion facilitates reducing an amount of torque ripple produced by the axial flux electric motor.

In another aspect, an axial flux electric machine is provided. The axial flux electric machine comprises a rotor assembly configured to rotate about an axis of rotation. A stator core is coupled to the rotor assembly. The stator core comprises a stator core base and a plurality of circumferentially-spaced stator teeth extending from the base in a direction parallel to the axis. Each stator tooth of the plurality of stator teeth comprises a top surface, a pair of opposing circumferential sides, and a modified portion defined at an intersection of the top surface and each of the pair of opposing sides. The modified portion facilitates reducing an amount of torque ripple produced by the axial flux electric motor.

In yet another aspect, a method of manufacturing a stator core for an axial flux electric machine is provided. The method comprises forming a plurality of circumferentially-spaced stator teeth, wherein each stator tooth of the plurality of stator teeth includes a top surface and a pair of opposing circumferential sides. The method further comprises forming a modified portion at an intersection of the top surface and each of the pair of opposing sides to facilitate reducing an amount of torque ripple produced by the axial flux electric motor.

### BRIEF DESCRIPTION OF THE DRAWINGS

The embodiments described herein relate generally to axial flux electrical machines, and more particularly, to methods and systems for reducing torque ripple using a stator core in an axial flux electric machine.

FIG. 1 is a cross-sectional view of an exemplary axial flux electric machine.

FIG. 2 is an exploded view of the axial flux machine shown in FIG. 1.

FIG. 3 is an enlarged view of a portion of an exemplary stator core outlined by box 3-3 shown in FIG. 2 that illustrates modifying of an exemplary stator tooth.

FIG. 4 is a perspective view of a chamfered stator tooth shown in FIG. 3.

FIG. 5 is a perspective view of an alternative embodiment of a modified stator tooth that may be used with the stator core shown in FIG. 3.

FIG. 6 is a perspective view of another alternative embodiment of a modified stator tooth that may be used with the stator core shown in FIG. 3.

FIG. 7 is a perspective view of yet another alternative embodiment of a modified stator tooth that may be used with the stator core shown in FIG. 3.

FIG. 8 is a graphical representation of the magnitudes of noise reduction and torque losses versus various tooth chamfer sizes used on the stator core shown in FIG. 3.

### DETAILED DESCRIPTION

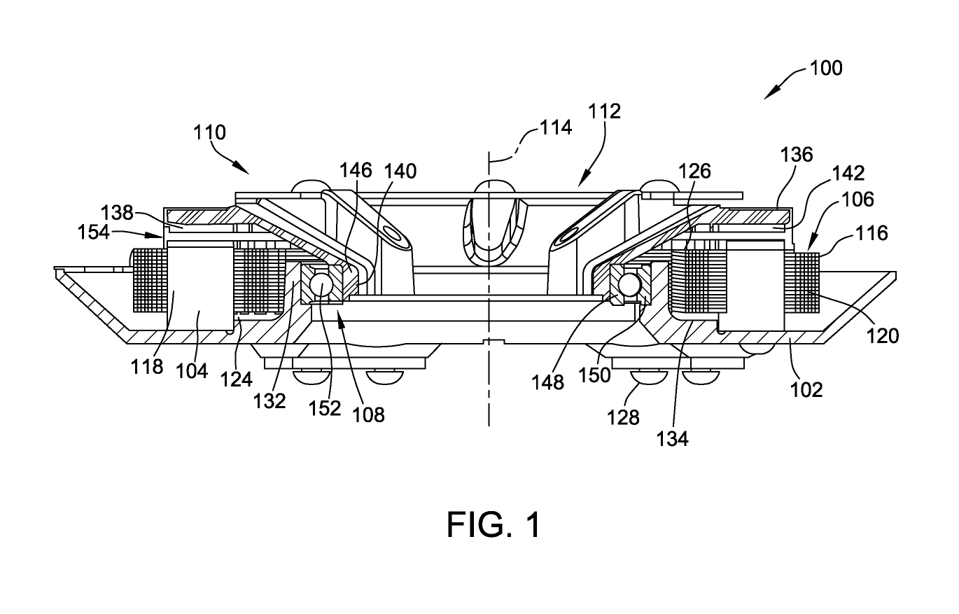

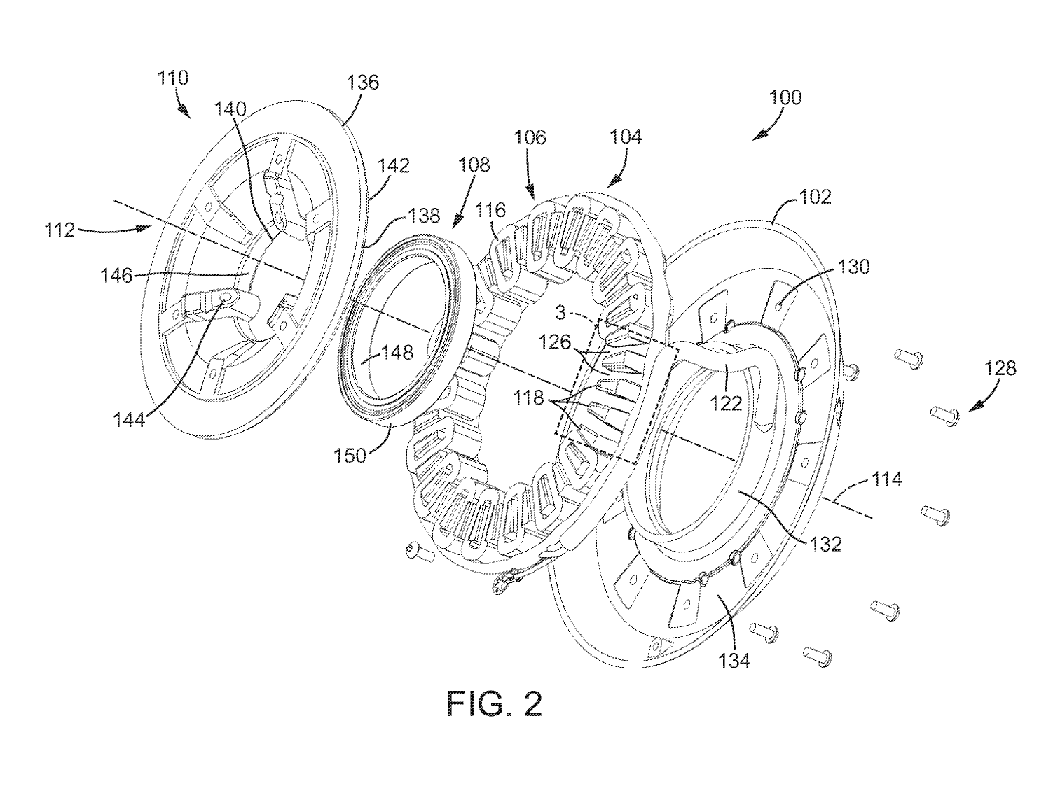

FIG. 1 is a cross-sectional view of an exemplary axial flux electric machine 100. FIG. 2 is an exploded view of axial flux electric machine 100. Although machine 100 is described herein as an axial flux machine, machine 100 may alternatively be a radial flux machine. In the exemplary embodiment, electric machine 100 is an electric pancake motor. Alternatively, electric machine 100 may operate as either a motor or a generator. Components common to FIGS. 1 and 2 are identified with the same reference numerals.

In the exemplary embodiment, electric machine 100 is coupled to a work component (not shown) included within a commercial and/or industrial application. The work component may include, but is not limited to, a pump system, an air handling unit, and/or manufacturing machinery (e.g., conveyors and/or presses). In an alternative embodiment, the work component may include a fan for moving air through an air handling system, for blowing air over cooling coils, and/or for driving a compressor within an air conditioning/refrigeration system. More specifically, machine 100 may be used in air moving applications used in the heating, ventilation, and air conditioning (HVAC) industry.

Electric machine 100 includes a housing 102, a stator core 104, a bobbin assembly 106, a bearing assembly 108, and a rotor assembly 110. Each of housing 102, stator core 104, bearing assembly 108, and rotor assembly 110 includes a concentric opening 112 oriented about an axis of rotation 114. Bobbin assembly 106 includes a plurality of bobbins 116 that each include an opening (not shown) that closely conforms to an external shape of one of a plurality of stator core teeth 118 such that each stator tooth 118 is configured to be positioned within a bobbin 116. Machine 100 may include one bobbin 116 per stator tooth 118 or one bobbin 116 positioned on every other tooth 118. In the exemplary embodiment, each bobbin 116 is configured to insulate a plurality of copper windings 120 such that each bobbin 116 electrically insulates one winding 120 from a respective stator tooth 118.

In the exemplary embodiment, a variable frequency drive (not shown) provides a signal, for example, a pulse width modulated (PWM) signal, to electric machine 100. In an alternative embodiment, electric machine 100 may include a controller (not shown) coupled to bobbin assembly 106 by wiring 122. The controller is configured to apply a voltage to one or more of bobbins 116 at a time for commutating bobbin assembly 106 in a preselected sequence to rotate rotor assembly 110 about axis 114.

Stator core 104 includes a plurality of circumferentially-spaced stator teeth 118 that extend in the Y-direction parallel to axis of rotation 114 from a stator core base 124. In the exemplary embodiment, stator core includes thirty-six teeth 118. Alternatively, stator core 104 may include any suitable number of teeth 118 that allow machine 100 to function as described herein. In use, stator core base 124 is positioned perpendicularly about rotational axis 114 such that plurality of teeth 118 extend in the Y-direction from stator core base 124 and form a slot 126 between each adjacent tooth 118. Referring to FIG. 2, a number of bobbins 116 of bobbin assembly 106 have been removed for clarity to show slots 126 and teeth. In the exemplary embodiment, stator core 104 is an open slot stator core, and as such, does not include tooth extensions that may extend from each side of each tooth 118 towards adjacent teeth 118. In addition, each slot between adjacent stator teeth 118 is easily accessible for receiving a bobbin 116 from the plurality of bobbins 116, as described above. Alternatively, stator core 104 may be a high efficiency semi-closed stator core that includes tooth extensions.

In the exemplary embodiment, stator core 104 is an annular ring having an aperture 112 therethrough. Stator core 104 is coupled to housing 102 by threading a plurality of fasteners 128 through a plurality of apertures 130 in housing 102 and into corresponding apertures (not shown) in stator core 104. Housing 102 includes a secondary bearing locator 132 extending from an inner face 134 of housing 102 that facilitates retaining bearing assembly 108 in place. In the exemplary embodiment, stator core 104 is a strip wound core manufactured from a long steel ribbon wound into a toroidal shape. A number of slots are punched into a single layer of the ribbon by a punch and wind machine (not shown), and as the ribbon is wound, the slots of the single layers combine to form slots 126 and teeth 118. Alternatively, stator core 104 is a laminated core comprised of a number of laminated sheets. Copper windings 120 are then covered by a bobbin 116 and slid over a tooth 118. Alternatively, windings 120 are wound around teeth 118 and are insulated from adjacent teeth by an insulating layer (not shown).

Rotor assembly 110 includes a rotor disk 136 having at least an axially inner surface 138 and a radially inner wall 140 that at least partially defines opening 112. Rotor assembly 110 also includes a plurality of permanent magnets 142 coupled to inner surface 138 of rotor disk 136. In the exemplary embodiment, magnets 142 are coupled to rotor disk 136 using an adhesive. Alternatively, magnets 142 may be coupled to disk 136 using any retention method that facilitates operation of machine 100 as described herein. Plurality of permanent magnets 142 are symmetrical, which facilitates manufacturing a single magnet design for use with each magnet 142 within the plurality of permanent magnets 142. Alternatively, plurality of magnets 142 may be non-symmetrical. Furthermore, each magnet 142 has a substantially flat profile which minimizes waste during manufacturing, and therefore, minimizes cost. Magnets 142 are preferably composed of Neodymium Iron Boron (NdFeB) material. However, alternative materials such as Samarium Cobalt or Ferrite are suitable. Rotor disk 136 further includes mounting apertures 144 for mounting rotor disk 136 to a workpiece (not shown) and a primary bearing locator 146 extending from inner surface 138 for facilitating proper positioning of bearing assembly 108. In the exemplary embodiment, rotor disk 136 is manufactured using a sintering process from, for example, Soft Magnetic Alloy (SMA), Soft Magnetic Composite (SMC), and/or powdered ferrite materials. In an alternative embodiment, rotor disk 136 is machined and/or cast from a solid metal, for example, steel. Similarly, stator core 104 is comprised of a metal, such as a steel alloy, that provides a magnetic attraction between permanent magnets 142 and stator 104 to retain rotor disk 136, bearing assembly 108, and stator 104 in place within machine 100.

Bearing assembly 108 is secured between secondary bearing locator 132 and primary bearing locator 146. Bearing assembly 108 includes an inner race 148 and an outer race 150 with a plurality of ball bearings 152 positioned therebetween. Primary bearing locator 146 of rotor disk 136 engages and locates bearing assembly 108 by engaging outer race 150 of bearing assembly 108. In turn, housing 102 includes an inner face 134 from which extends a secondary bearing locator 132 such that it engages inner race 148 of bearing assembly 108 to further position bearing assembly 108 and to secure bearing assembly 108 between stator core 104 and rotor disk 136. The magnetic force between magnets 142 coupled to rotor assembly 110 and stator 104 acts to hold machine 100 together. Further, bearing assembly 108 provides an axially-oriented air gap 154 between rotor disk 136 and stator core 104 that facilitates rotation of rotor assembly 110 relative to stator core 104.

In operation, bobbins 116 coupled to stator core 104 are energized in a chronological sequence that provides an axial magnetic field which moves clockwise or counterclockwise around stator core 104 depending on the pre-determined sequence or order in which bobbins 116 are energized. This moving magnetic field intersects with the flux field created by the plurality of permanent magnets 142 to cause rotor assembly 110 to rotate about axis 114 relative to stator core 104 in the desired direction to develop a torque which is a direct function of the intensities or strengths of the magnetic fields.

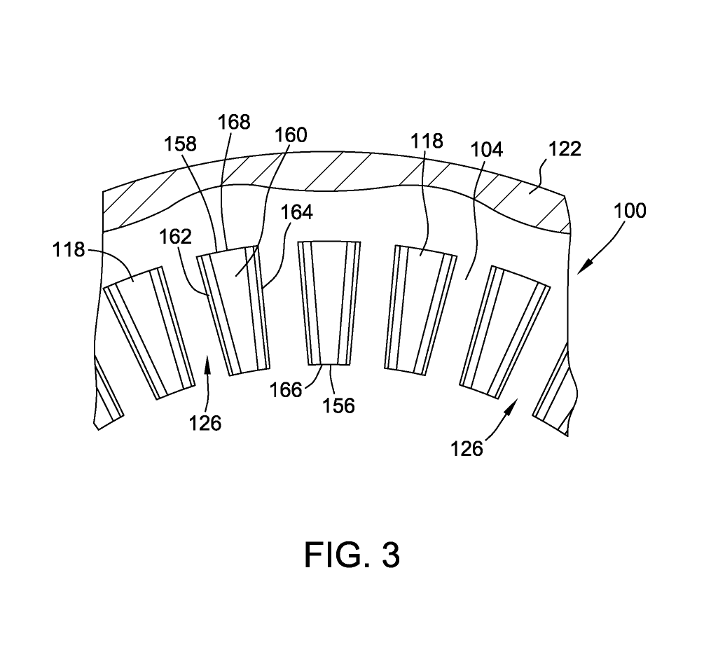

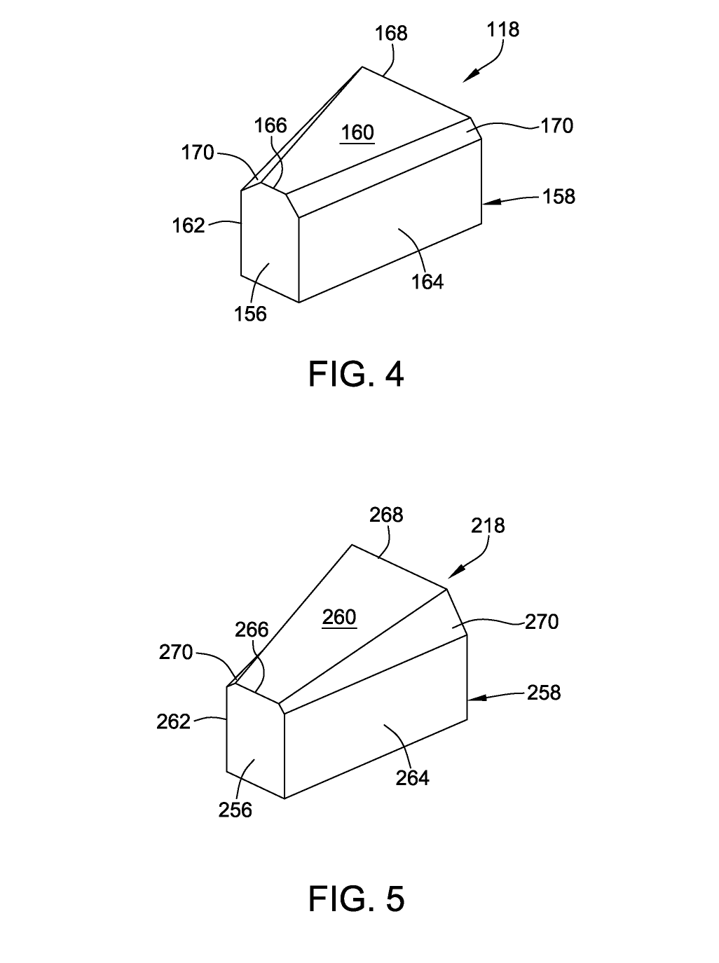

FIG. 3 is an enlarged view of a portion of stator core 104 outlined by box 3-3 shown in FIG. 2 that illustrates modification of stator tooth 118. Bobbins 116 of bobbin assembly 106 have been removed from FIG. 3 for clarity. FIG. 4 is an enlarged perspective view of stator tooth 118 illustrating tooth 118 modification by chamfering a portion of stator tooth 118. In the exemplary embodiment, each stator tooth 118 includes a radially inner surface 156 that at least partially defines an inner diameter (not shown) of stator core 104 and a radially outer surface 158 that at least partially defines an outer diameter (not shown) of stator core 104. Moreover, each tooth 118 includes a top surface 160 proximate magnets 142 (shown in FIGS. 1 and 2) and two opposing circumferential sides that include a first side 162 and a second side 164. A radially inner edge 166 is defined at the intersection of radially inner face 156 and top surface 160. Similarly, a radially outer edge 168 is defined at the intersection of radially outer surface 158 and top surface 160. A circumferential width of each tooth 118 decreases in the radially inward direction from surface 158 to surface 156. A circumferential width of each slot 126 extending in the radial direction between adjacent teeth 118 has a predetermined constant value in the radial direction.

In the exemplary embodiment, each tooth includes a modified portion 170 at the intersection of first side 162 and top surface 160 and also at the intersection of second side 164 and top surface 160. Modified portion 170 extends substantially an entire radial length of each tooth between inner surface 156 and outer surface 158. Modified portion 170 facilitates reducing torque ripple generated by machine 100, and therefore reduces the amount of noise produced by machine 100. In the exemplary embodiment, modified portion 170 includes a chamfer at the intersection of first side 162 and top surface 160 and also at the intersection of second side 164 and top surface 160. Modified portion 170 is formed during manufacture of stator core 104 such that when the punch and wind machine punches the slot from the ribbon, it also forms the chamfer on stator teeth 118. Previous attempts to chamfer edges resulted in deformed tooth shape. The punch and wind method of manufacturing produces consistent chamfer dimensions along portion 170 without deforming teeth 118. More specifically, the punch and wind machine forms the chamfer of modified portions 170 on the circumferential sides 162 and 164 or each tooth 118, while radially inner edge 166 and radially outer edge 168 remain unchanged except to account for modified portion 170.

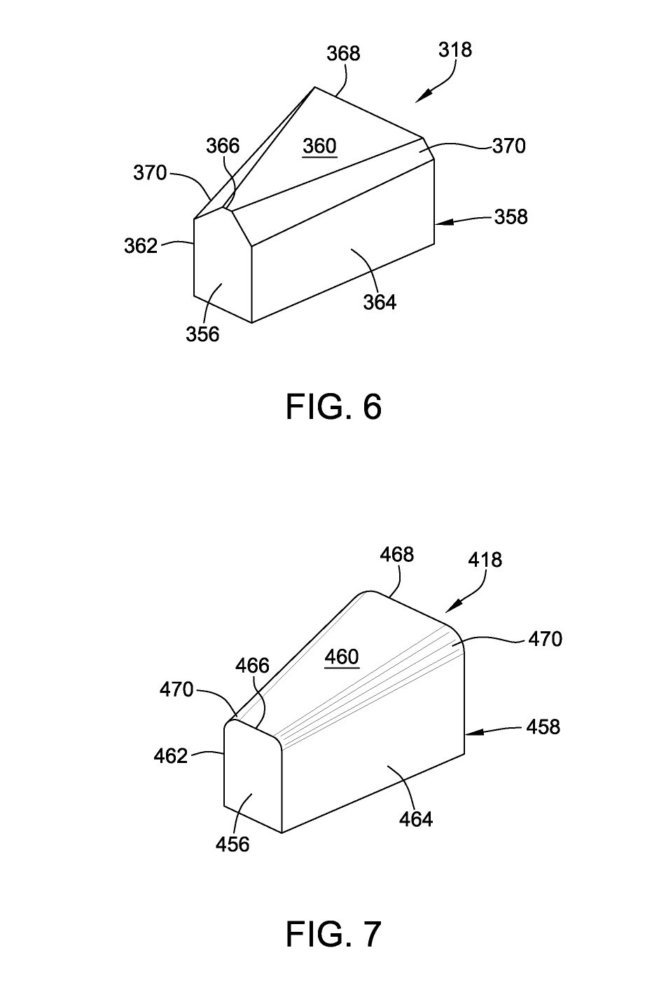

In the exemplary embodiment, modified portion 170 has a constant chamfer width in the range of between approximately 0.5 millimeters (mm) and approximately 2.0 mm between inner surface 156 and outer surface 158. More specifically, modified portion 170 has a constant chamfer width in the range of between approximately 1.0 mm and approximately 1.5 mm. Alternatively, modified portion 170 may have any size chamfer width that facilitates operation of machine 100 as described herein. Furthermore, modified portion 170 may be tapered to have a varying width, as is shown in FIGS. 5 and 6. FIG. 5 is a perspective view of an alternative embodiment of tooth modification on a stator tooth 218 that may be used with stator core 104 (shown in FIG. 3). Each stator tooth 218 includes a radially inner surface 256 and a radially outer surface 258 that are substantially similar to surfaces 156 and 158 (shown in FIG. 4). Moreover, each tooth 218 includes a top surface 260 and two opposing circumferential sides that include a first side 262 and a second side 264. A radially inner edge 266 is defined at the intersection of radially inner surface 256 and top surface 260. Similarly, a radially outer edge 268 is defined at the intersection of radially outer surface 258 and top surface 160.

Each tooth 218 includes a modified portion 270 at the intersection of first side 262 and top surface 260 and also at the intersection of second side 264 and top surface 260. Modified portion 270 includes a chamfered portion that decreases in width between radially outer surface 258 and radially inner surface 256. Similarly, FIG. 6 shows an alternative stator tooth 318 that may be used with stator core 104 (shown in FIG. 3). Each stator tooth 318 includes a radially inner surface 356 and a radially outer surface 358 that are substantially similar to surfaces 156 and 158 (shown in FIG. 4). Moreover, each tooth 318 includes a top surface 360 and two opposing circumferential sides that include a first side 362 and a second side 364. A radially inner edge 366 is defined at the intersection of radially inner surface 356 and top surface 360. Similarly, a radially outer edge 368 is defined at the intersection of radially outer surface 358 and top surface 360. Each tooth 318 includes a modified portion 370 at the intersection of first side 362 and top surface 360 and also at the intersection of second side 364 and top surface 360. Modified portion 370 includes a chamfered portion that increases in width between radially outer surface 358 and radially inner surface 356.

In the embodiments described above, stator teeth 118, 218, and 318 are each provided with modified portions 170, 270, and 370, respectively. A alternative embodiment is illustrated in FIG. 7. Instead of chamfered modified portions 170, 270, and 370, a stator tooth 418 is provided with a modified portion 470 that includes a rounded portion having a substantially arc shaped cross-section in the radial direction. Each stator tooth 418 includes a radially inner surface 456 and a radially outer surface 458 that are substantially similar to surfaces 156 and 158 (shown in FIG. 4). Moreover, each tooth 418 includes a top surface 460 and two opposing circumferential side that include a first side 462 and a second side 464. A radially inner edge 466 is defined at the intersection of radially inner surface 456 and top surface 460. Similarly, a radially outer edge 468 is defined at the intersection of radially outer surface 458 and top surface 460. Modified portion 470 is positioned at the intersection of first side 462 and top surface 460 and also at the intersection of second side 464 and top surface 460. In addition, modified portion 470 may change in size between radially outer surface 458 and radially inner surface 456.

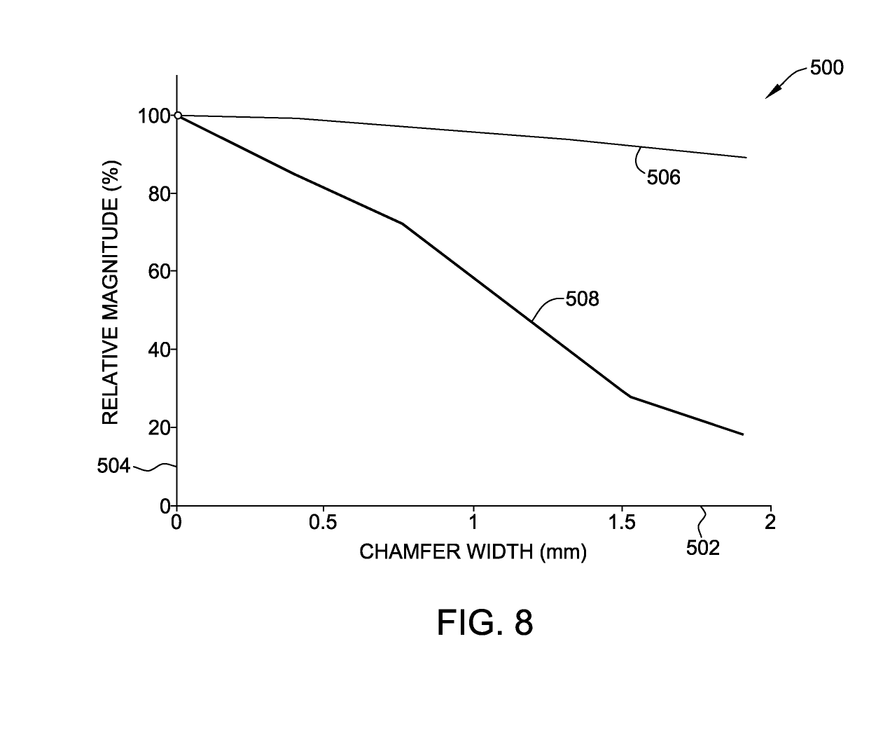

FIG. 8 is a graphical representation 500 of exemplary magnitudes of noise reduction and torque losses versus various tooth chamfer sizes used on stator core 104 of exemplary machine 100 (both shown in FIGS. 1 and 2). An x-axis 502 represents a constant width of chamfered modified portion 170 in millimeters (mm), and a y-axis 504 represents a relative magnitude loss of both torque and noise produced by machine 100. A reference line 506 represents the amount of torque loss as a percent magnitude at various chamfer widths compared to zero loss at a zero chamfer. A reference line 508 represents the torque ripple produced by machine 100 as measured by the 90^{th} harmonic. As shown in FIG. 8, graph 500 indicates a significant drop in torque ripple with only minimal losses in actual torque produced by machine 100 as a result of forming modified portion 170 on stator teeth 118. For example, reference line 508 indicates approximately a 50% loss in torque ripple at a chamfer width of 1.14 mm, while reference line 506 indicates only approximately a 2% loss in torque production at a chamfer width of 1.14 mm. Such a reduction in torque ripple results in significantly quieter machine operation, while maintaining substantially the same amount of torque production. Furthermore, air gap 154 (shown in FIG. 1), between the stator teeth and the rotor assembly, may be decreased to recover at least a portion of the minimal torque losses.

In the example shown in FIG. 8, the amount of noise is measured at the 90^{th} harmonic of machine 100. It should be appreciated by one of ordinary skill in the art that tooth modification, and specifically tooth chamfering, reduces the noise level for different motors at different harmonics and that, in this case, the 90^{th} harmonic is being used as an example only and does not limit the scope or spirit of the claims. More specifically, measuring the 90^{th} harmonic is an example for the 30 pole/36 slot machine 100 and other harmonics that are inherent to other machines having different pole counts and slot counts will also benefit from tooth modifications based on the machine's size and operating parameters.

The axial flux electric machine described herein includes a plurality of stator teeth that include modified edges that facilitate reducing torque ripple produced by the machine while maintaining a substantially constant amount of total torque production. The tooth modifications are formed at the intersection of the circumferential sides and the top surface of each tooth. The modification may include a chamfered portion having a constant width along a radial length of the tooth, or the chamfered portion may be tapered such that the width of the chamfer either increases or decreases from an radially inner surface of the tooth to a radially outer surface. The circumferential edges of each tooth may alternatively be rounded or notched to facilitate reducing torque ripple. Furthermore, forming the chamfered portions on a steel ribbon during manufacture of the stator core using a punch and wind machine facilitates forming the chamfered portions without deforming the shape of the stator teeth, therefore reducing the time and cost required for fabrication. Reducing the torque ripple caused by the machine significantly reduces the amount of noise that the machine produces. The modified stator teeth facilitate reducing the torque ripple, and therefore the noise generated, while maintaining a substantially constant amount of torque generated by the machine.

The embodiments described herein relate to axial flux permanent magnet electrical machines and methods of manufacturing the same. More specifically, the embodiments relate to a stator core that reduces torque ripple and diminishes the noise produced by the machine. More particularly, the embodiments relate to forming opposing modified portions on each stator tooth of the stator core to soften the interaction of magnetic flux from a permanent magnet on the stator tooth and therefore reduce torque ripple. The methods and apparatus are not limited to the specific embodiments described herein, but rather, components of apparatus and/or steps of the methods may be utilized independently and separately from other components and/or steps described herein. For example, the methods may also be used in combination with radial flux electric machines and methods, and are not limited to practice with only the axial flux electric machines and methods as described herein. Rather, the exemplary embodiment can be implemented and utilized in connection with many other electrical machine applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A stator core for an axial flux electric machine, said stator core comprising:
an axis of rotation;
a stator core base; and
a plurality of circumferentially-spaced stator teeth extending from said base in a direction parallel to said axis, wherein each stator tooth comprises:
a top surface;
a pair of opposing circumferential sides; and
a modified portion defined at an intersection of said top surface and each of said pair of opposing sides, wherein said modified portion facilitates reducing an amount of torque ripple produced by the axial flux electric machine.

2. The stator core according to claim 1, wherein each of said stator teeth further comprises a radially outer surface and a radially inner surface spaced apart by said opposing sides such that a tooth length is defined between said radially inner and radially outer surfaces.

3. The stator core according to claim 2, wherein said modified portion includes a chamfered portion including a constant chamfer width along said stator tooth length.

4. The stator core according to claim 3, wherein said constant chamfer width is in the range of between approximately 0.5 millimeters and 2.0 millimeters.

5. The stator core according to claim 2, wherein said modified portion includes a chamfered portion including a tapered width between said radially inner surface and said radially outer surface.

6. The stator core according to claim 2, wherein said modified portion includes a rounded portion along said stator tooth length.

7. An axial flux electric machine comprising:
a rotor assembly configured to rotate about an axis of rotation; and
a stator core coupled to said rotor assembly, said stator core comprising a stator core base and a plurality of circumferentially-spaced stator teeth extending from said base in a direction parallel to said axis, wherein each stator tooth comprises:
a top surface;
a pair of opposing circumferential sides; and
a modified portion defined at an intersection of said top surface and each of said pair of opposing sides, wherein said modified portion facilitates reducing an amount of torque ripple produced by the axial flux electric machine.

8. The axial flux electric machine according to claim 7, wherein each of said stator teeth further comprises a radially outer surface and a radially inner surface spaced apart by said opposing sides such that a tooth length is defined between said radially inner and radially outer surfaces.

9. The axial flux electric machine according to claim 8, wherein said modified portion includes a chamfered portion including a constant chamfer width along said stator tooth length.

10. The axial flux electric machine according to claim 9, wherein said constant chamfer width is in the range of between approximately 0.5 millimeters and 2.0 millimeters.

11. The axial flux electric machine according to claim 8, wherein said modified portion includes a chamfered portion including a tapered width that increases from said radially inner surface to said radially outer surface.

12. The axial flux electric machine according to claim 8, wherein said modified portion includes a chamfered portion including a tapered width that decreases from said radially inner surface to said radially outer surface.

13. The axial flux electric machine according to claim 8, wherein said modified portion includes a rounded portion along said stator tooth length.

14. The axial flux electric machine according to claim 7 further comprising a bearing assembly and a housing, wherein said housing comprises a secondary bearing locator and said rotor assembly comprises a primary bearing locator, and wherein said bearing assembly is engaged by said primary and secondary bearing locators to position said bearing assembly.

15. A method of manufacturing a stator core for an axial flux electric machine, said method comprising:
forming a plurality of circumferentially-spaced stator teeth, wherein each stator tooth of the plurality of stator teeth includes a top surface and a pair of opposing circumferential sides; and
forming a modified portion at an intersection of the top surface and each of the pair of opposing sides to facilitate reducing an amount of torque ripple produced by the axial flux electric motor.

16. The method according to claim 15 further comprising forming the plurality of stator teeth to include a radially outer surface and a radially inner surface that are spaced apart by the opposing sides such that a tooth length is defined between the radially inner and radially outer surfaces.

17. The method according to claim 16 further comprising forming a modified portion that includes a chamfered portion including a constant chamfer width along the stator tooth length.

18. The method according to claim 17 further comprising forming the constant chamfer width within the range of between approximately 0.5 millimeters and 2.0 millimeters.

19. The method according to claim 17 further comprising forming a modified portion that includes a chamfered portion including a tapered chamfer width between the radially inner surface and the radially outer surface.

20. The method according to claim 15 further comprising forming a modified portion that includes a rounded portion.
